(19) United States
(12) Patent Application Publication
(10) Pub. No.: US 2015/0242088 A1
(43) Pub. Date: Aug. 27, 2015

(54) IMAGE DISPLAY PROGRAM AND IMAGE DISPLAY DEVICE

(71) Applicant: NIKON CORPORATION, Tokyo (JP)

(72) Inventor: Tomohisa Hasumi, Kawaguchi-shi (JP)

(21) Appl. No.: 14/381,060

(22) PCT Filed: Feb. 27, 2013
(86) PCT No.: PCT/JP2013/055210

§ 371 Date: Feb. 24, 2015

(30) Foreign Application Priority Data
Feb. 27, 2012 (JP) 2012-040158

(51) Int. Cl. G06F 3/0481; G06F 3/0482; G06F 3/0484

(52) U.S. Cl. CPC G06F 3/04817; G06F 3/04845; G06F 3/0482; G06F 3/04842

(57) ABSTRACT

An image display program enables a computer to execute: a function of displaying an image based upon image data; a function of readying an icon based upon photographing location information indicating a photographing location, which is made to correspond to the image data, by drawing a pointer indicating the photographing location on a graphic figure representing an approximate shape of a region unit containing the photographing location; and a function of displaying the icon having been readied together with the image to be displayed.

### TECHNICAL FIELD

The present invention relates to an image display program and an image display device used to display an image based upon image data.

### BACKGROUND ART

In recent technological development, photographing location information, obtained via a GPS receiver, is embedded in an image file and the image is linked to a map based upon the embedded photographing location information. For instance, a map information display device disclosed in patent literature 1 obtains, based upon photographing location information read out from an image file, map information pertaining to a region that includes the particular photographing location via a network or the like, and displays the map information together with the image. In the map information, the photographing location where the image was photographed is clearly indicated with a pointer.

### CITATION LIST

### Patent Literature

Patent literature 1: Japanese Laid Open Patent Publication No. 2009-58922

### SUMMARY OF INVENTION

### Technical Problem

The map information described above, which requires a relatively large display area, is bound to occupy some of the display area that would otherwise be used to display the image at the same time. In other words, the image cannot be displayed over a large display area or a large number of images cannot be displayed at once.

According to the 1st aspect of the present invention, an image display program enables a computer to execute: a function of displaying an image based upon image data; a function of readying an icon based upon photographing location information indicating a photographing location, which is made to correspond to the image data, by drawing a pointer indicating the photographing location on a graphic figure representing an approximate shape of a region unit containing the photographing location; and a function of displaying the icon having been readied together with the image to be displayed.

According to the 2nd aspect of the present invention, in the image display program according to the 1st aspect, it is preferred that in a readying phase during which the icon is readied, a decision is made in correspondence to a condition as to whether to use an icon with a predetermined unit designation corresponding to a predetermined region unit or to use an icon with a lower-level unit designation corresponding to a lower-level region unit relative to the predetermined region unit.

According to the 3rd aspect of the present invention, in the image display program according to the 2nd aspect, it is preferred that a decision is made as to whether to use the icon with the predetermined unit designation or the icon with the lower-level unit designation based upon a user setting selected in advance.

According to the 4th aspect of the present invention, in the image display program according to the 3rd aspect, it is preferred that a setting indicating whether or not the icon with the lower-level unit designation is to be used can be selected in correspondence to each lower-level region unit, and a decision as to whether to use the icon with the predetermined unit designation or the icon with the lower-level unit designation is made based upon the setting.

According to the 5th aspect of the present invention, in the image display program according to the 2nd aspect, it is preferred that a decision as to whether to use the icon with the predetermined unit designation or the icon with the lower-level unit designation is made based upon the photographing location information.

According to the 6th aspect of the present invention, in the image display program according to the 5th aspect, it is preferred that the icon with the predetermined unit designation is readied if the photographing location indicated in the photographing location information is near a border separating two or more lower-level region units.

According to the 7th aspect of the present invention, in the image display program according to any one of the 1st through 6th aspects, it is preferred that when providing an at-a-glance display of thumbnail images based upon a plurality of sets of image data, the icon is readied and displayed in correspondence to each of the thumbnail images.

According to the 8th aspect of the present invention, an image display device comprises: a display unit at which an image can be displayed based upon image data; an icon readying unit that readies an icon based upon photographing location information indicating a photographing location, which is made to correspond to the image data, by drawing a pointer indicating the photographing location on a graphic figure representing an approximate shape of a region unit containing the photographing location; and a display control unit that displays the icon having been readied at the display unit together with the image to be displayed.

### Advantageous Effect of the Invention

According to the present invention, the photographing location can be indicated with a visual tool in the form of an icon instead of map information, and as a result, the photographing location information can be provided without encroaching on the image display area. Thus, it becomes possible to provide a large image display or to display a large number of images at once.

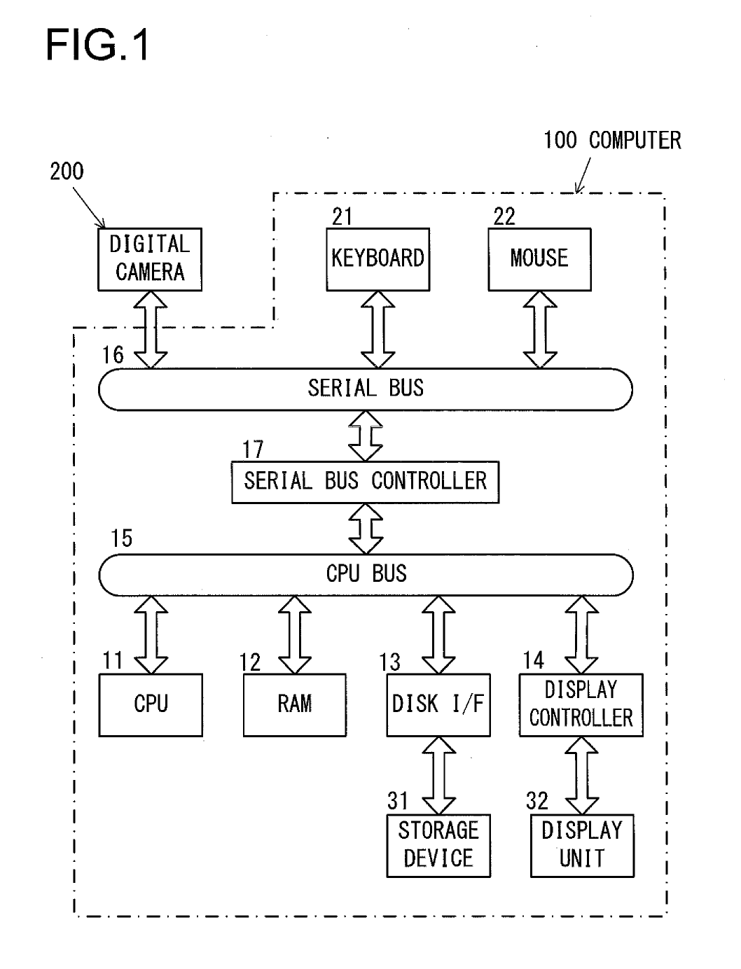

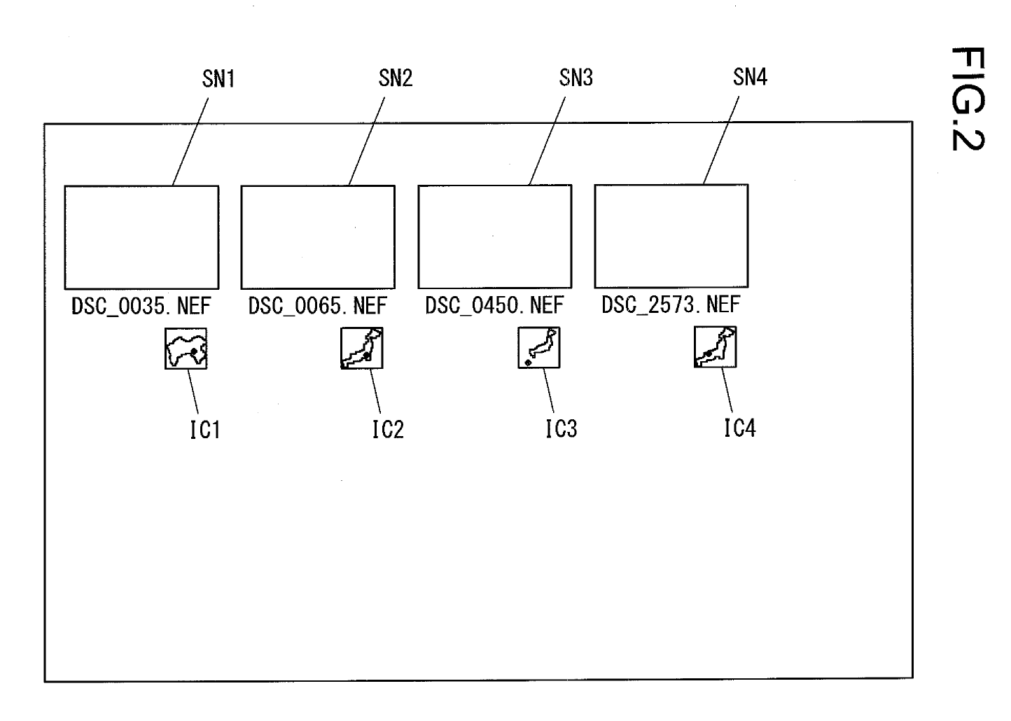

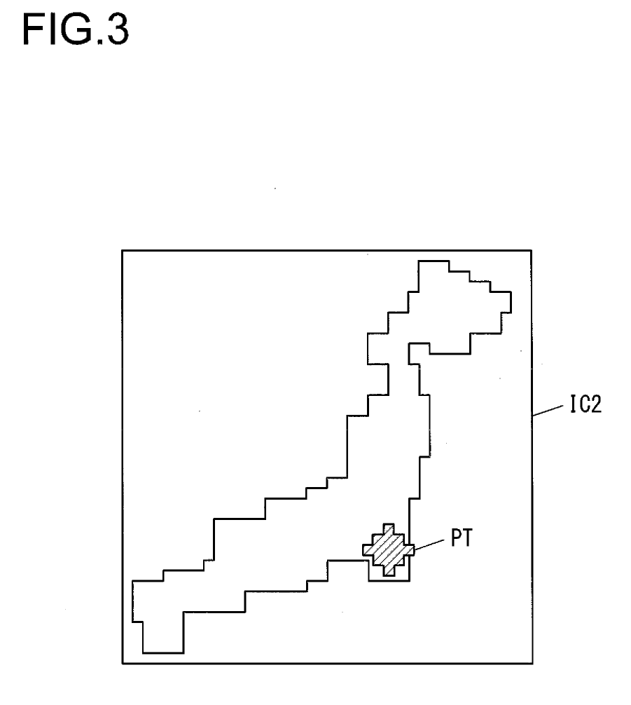

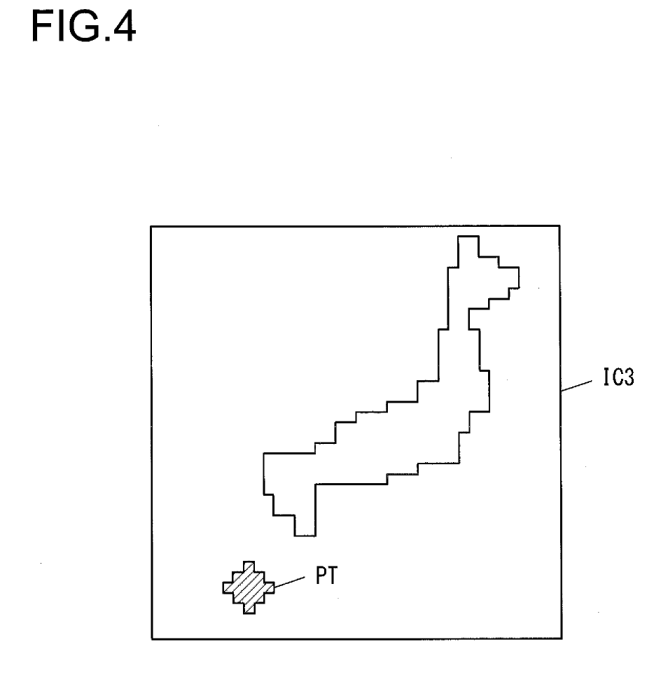

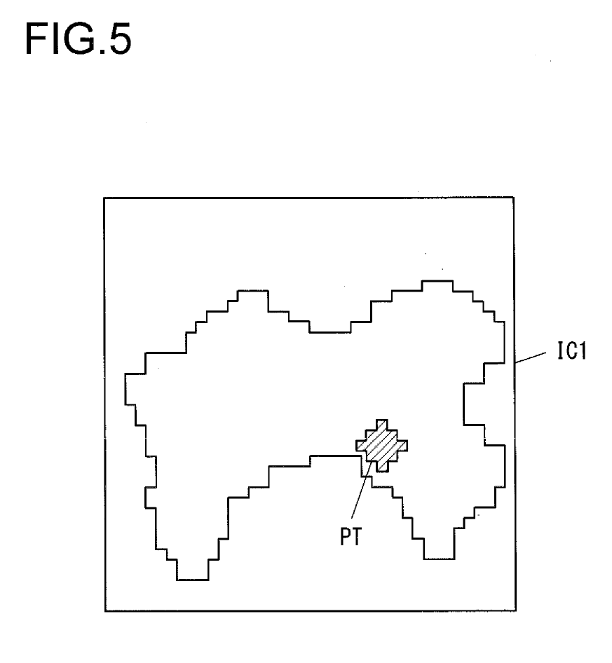

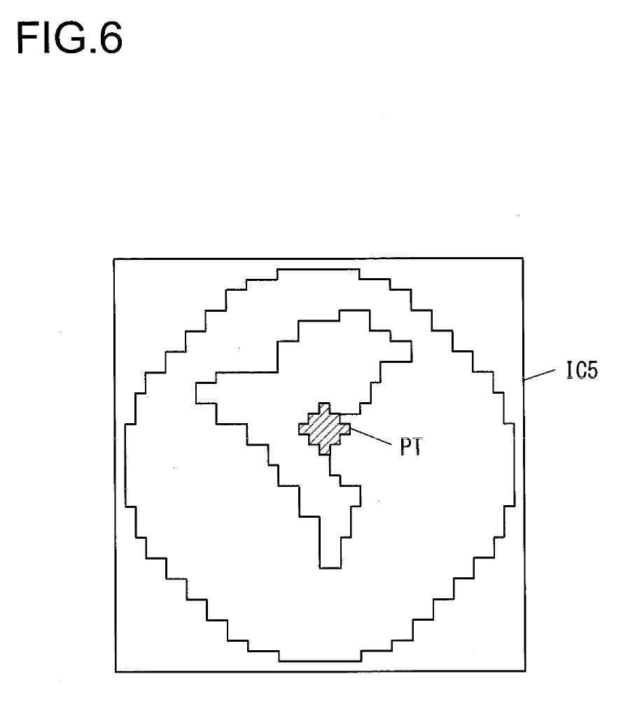

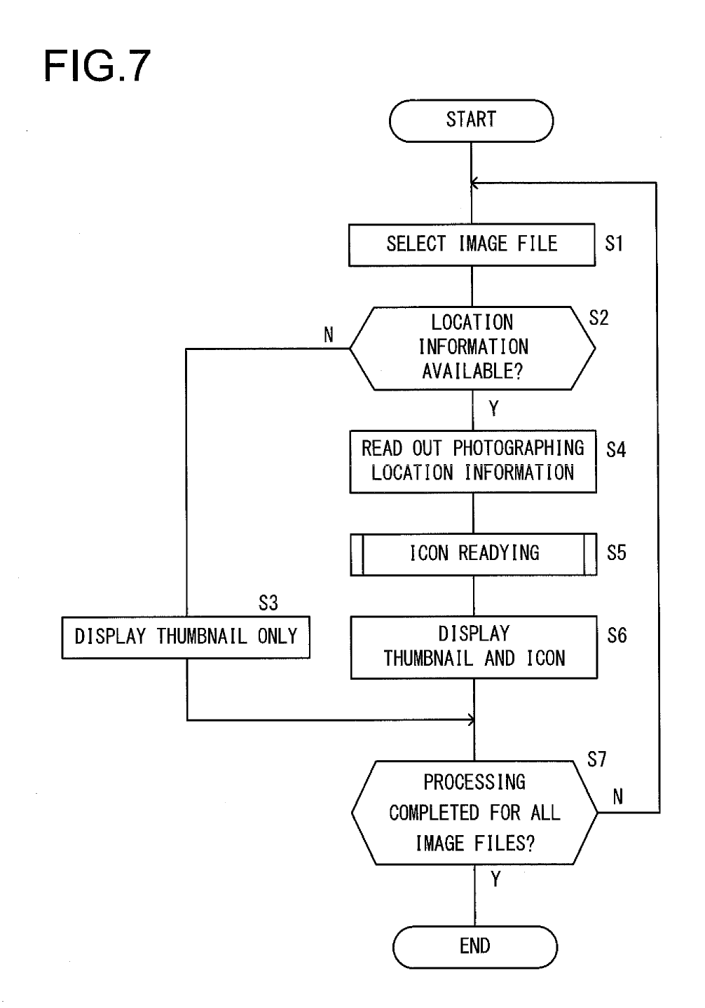

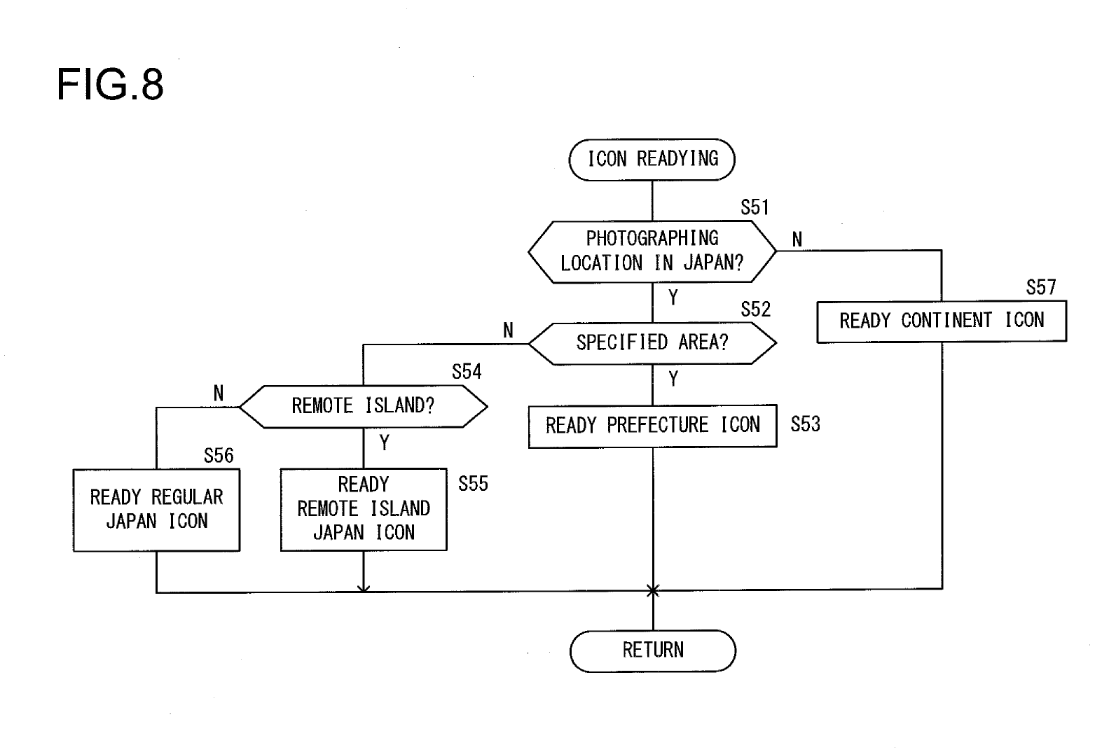

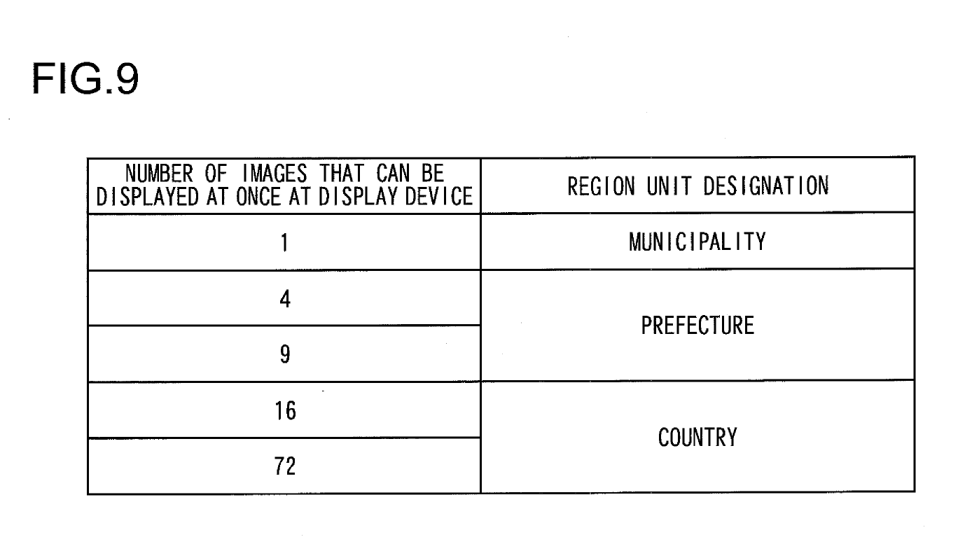

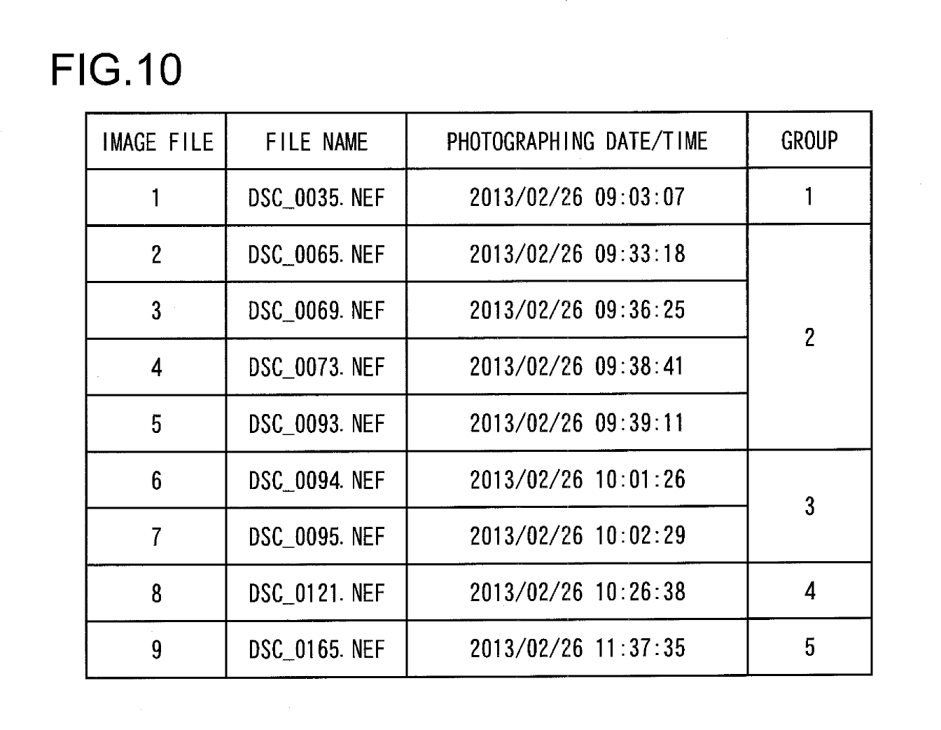

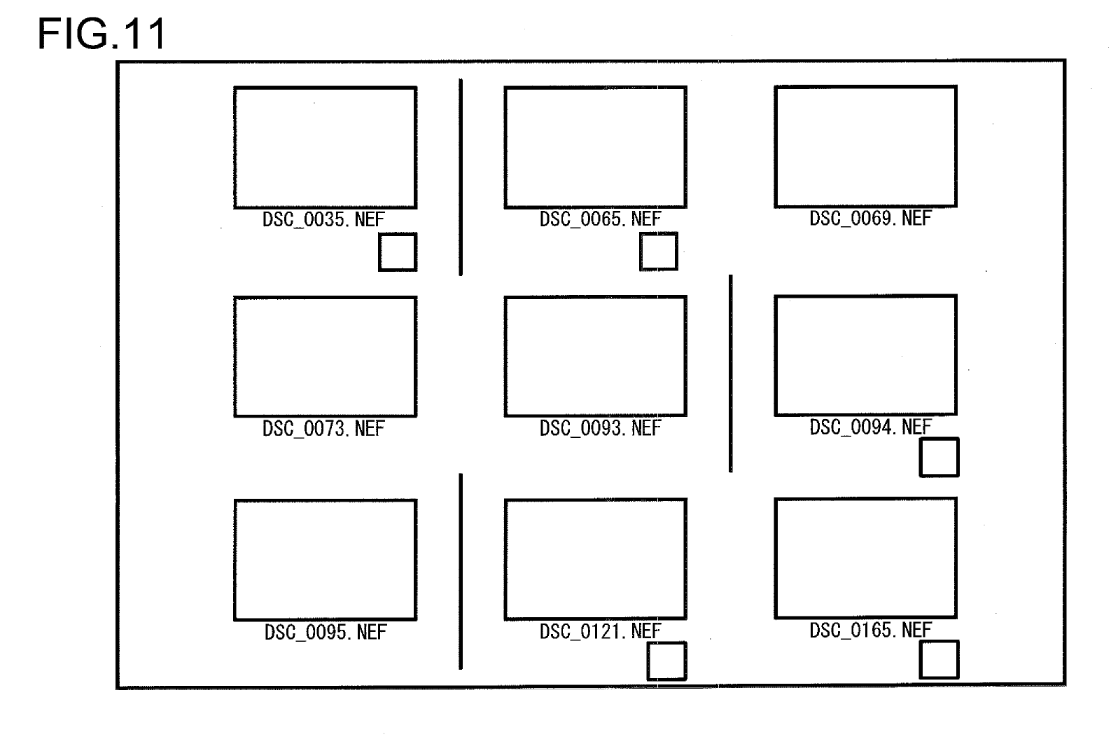

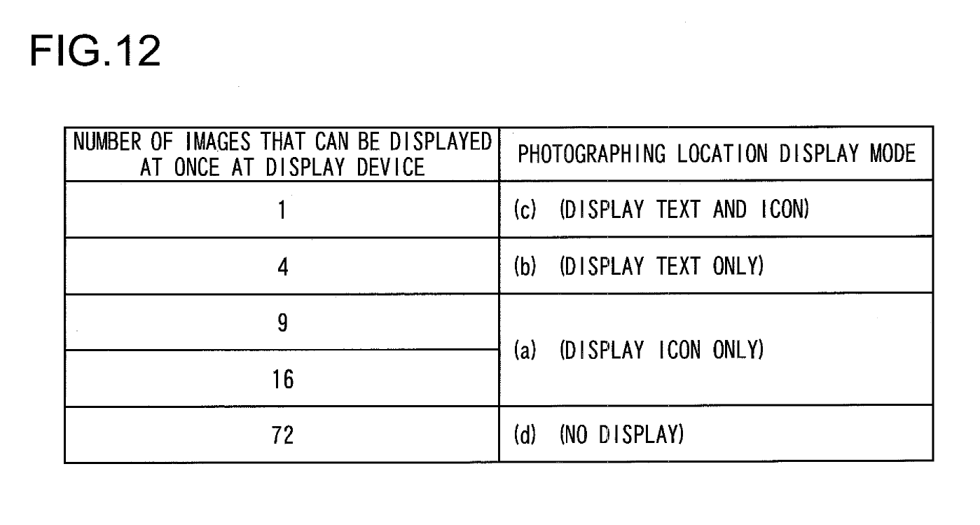

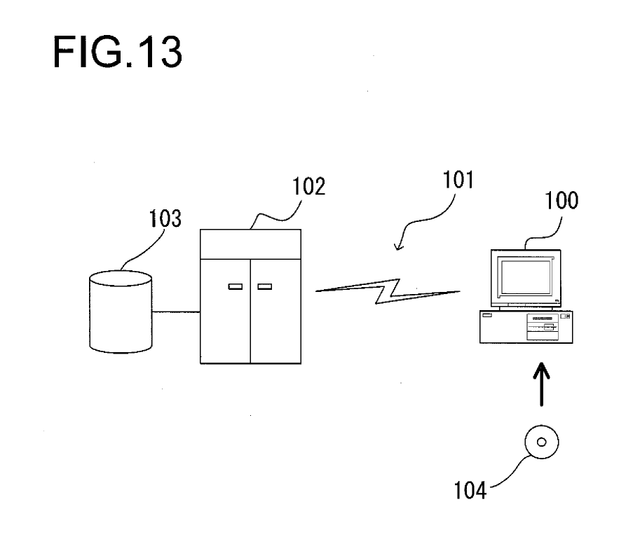

### BRIEF DESCRIPTION OF THE DRAWINGS

[FIG. 1] A schematic block diagram of the system achieved in an embodiment of the present invention

[FIG. 2] An example of a thumbnail at-a-glance display that may be brought up on the computer

[FIG. 3] An example of an icon for Japan

[FIG. 4] An example of an icon for Japan that includes a remote island

[FIG. 5] An example of an icon for a prefecture

[FIG. 6] An example of an icon for a continent

[FIG. 7] A flowchart of an example of a processing procedure for thumbnail at-a-glance display

[FIG. 8] A detailed flowchart of the icon readying processing in FIG. 7

[FIG. 9] A chart presenting an example of the correspondence between the number of images that can be displayed at once and the icon region unit designation

[FIG. 10] A chart indicating how a plurality of images are assigned to specific groups

[FIG. 11] An example display that may be brought up when the number of images that can be displayed at once is set to 9

[FIG. 12] A chart indicating how the icon display mode is switched in correspondence to the number of images that can be brought up on display

[FIG. 13] An illustration showing how the program may be provided

### DESCRIPTION OF EMBODIMENTS

### First Embodiment

An embodiment of the present invention will be described in reference to FIGS. 1 through 8.

FIG. 1 is a schematic block diagram of a system comprising a computer and a digital camera. A computer 100 comprises a main unit that includes a CPU 11, a RAM 12, a disk interface 13, a display controller 14, a CPU bus 15, a serial bus 16 and a serial bus controller 17, and further comprises input devices such as a keyboard 21 and a mouse 22, which are connected via the serial bus 16, a storage device (e.g., a hard disk) 31 connected via the disk interface 13, and a display unit 32 which functions as a display device. An image transfer program, an image display program and the like are installed in advance in the storage device 31.

A digital camera 200 is connected to the computer 100 via the serial bus 16. The CPU 11 in the computer 100 transfers an image file stored in a storage medium (such as a memory card) in the camera 200 to the storage device 31 following an instruction from the image transfer program, and reads out an image file in the storage device 31 and displays the image file as an image at the display unit 32 following an instruction from the image display program. It is to be noted that an image file may also be transferred by loading the memory card, having been taken out of the camera, at a reader device (not shown) in the computer 100, or image file transfer may be executed through wireless communication.

The camera creates an image file by combining image data, which are obtained through image capturing operation, thumbnail data for the image data, and metadata. The metadata, which are embedded as, for instance, file header information, include various types of information such as camera information, photographing date/time information, photographing location information (latitude/longitude information) and photographing conditions information. The photographing location information is obtained via a GPS receiver built into the camera, an external GPS unit mounted at the camera, or the like, and is embedded in the corresponding image file when the image is captured with the camera. In addition, the photographing location information may be embedded later into an image file that does not initially have photographing location information.

Next, the functions of the image display program will be described in detail.

As the user starts up the image display program and specifies a given folder in the storage device 31, the CPU 11 brings up a thumbnail at-a-glance display such as that shown in FIG. 2 on the display unit 32. The thumbnail images (SN1, SN2, . . . ) of the image files stored in the specified folder are thus displayed in the at-a-glance display. Icons (IC1, IC2, . . . ), each indicating a specific photographing location, are displayed directly under thumbnail images corresponding to image files when the photographing location information is embedded therein.

The icons described above are shown in enlarged views in FIGS. 3 through 6. It is to be noted that these icons are prepared for Japanese users or users residing in Japan. The icon design features a graphic figure representing an approximate shape of a region unit (division) that includes the photographing location where the corresponding image was photographed, with a point indicating the photographing location added thereto. The region unit depicted in the icon design will bear a designation “the whole of Japan”, a lower-level “prefecture” or “continent” designation. The last region unit designation is for icons used to indicate overseas photographing locations. Icons bearing these designations will be respectively referred to as a “Japan icon”, a “prefecture icon” and a “continent icon”. In this embodiment, all icons are always made up with 32×32 pixels.

It is to be noted that in addition to icons with the region unit designations described above, icons bearing a “municipality” designation, which is a lower-level designation to the “prefecture” designation and icons bearing an “8-region” designation (Hokkaido, Tohoku, Kanto, Chubu, Kinki, Chugoku, Shikoku and Kyushu Okinawa) which is a middle-level designation between the “whole of Japan” and the “prefecture”, and the like, may be used. The image display program marketed overseas will display icons representing the entire land of a specific overseas country and icons representing “states” and the like. It is to be noted that icons with a lower-level (lower order) designation represent narrower geographical ranges compared to icons with a higher-level (higher order) designation.

FIGS. 3 and 4 each shows a Japan icon. A Japan icon IC2 in FIG. 3, which does not include any remote island, is created as follows. The eastern, western, southern and northern ends (the main islands) of Japan are;

northernmost end 45°, 31′, 22″ north latitude (Cape Soya)
easternmost end 145°, 49′ east longitude (Cape Nosappu)
southernmost end 30°, 59′ 10″ north latitude (Cape Sata)
westernmost end 129°, 33′ east longitude (Kozaki hana)
The difference between the latitude at the southernmost end and the latitude at the northernmost end is approximately 14.54°, whereas the difference between the longitude at the easternmost end and the longitude at the westernmost end is approximately 16.27°. In other words, the Japanese land is elongated along the east-west direction. Accordingly, the lateral side (east-west) and the longitudinal side (south-north) are each divided into 10 segments in units of 1.627°, which is 1/10 of the east-west difference 16.27°. Since the icon is made up with 32×32 pixels, a 3×3-pixel icon area is allocated to each subdivision defined by dividing the 30×30-pixel area resulting from excluding the outermost single-pixel area at the periphery, into 10 subdivisions. A pixel present in a sea area will take on a pale blue color, whereas a pixel present in a land area will take on another appropriate color (pale colors are desirable). In addition, a point PT indicating the photographing location is made up with a single pixel corresponding to an area containing the position indicated by the photographing location information and several surrounding pixels, so as to achieve up/down left/right symmetry (made up with a total of 13 pixels in the figure). These pixels take on a color such as red, which allows the user to recognize the photographing location with ease.

A Japan icon IC3 in FIG. 4, which is used when the image was photographed in

Okinawa or on another remote island, is created as follows. The eastern, western, southern and northern ends of Japan including remote islands accessible by the public are:

northernmost end 45°, 31′, 22″ north latitude (Cape Soya)
southernmost end 24°, 47′, 16″ north latitude (Cape Takanazaki, Hateruma Island)
easternmost end 145°, 49′ east longitude (Cape Nosappu)
westernmost end 123°, 0′, 17″ east longitude (Cape Irizaki) Yonakuni Island)
The difference between the latitude at the southernmost end and the latitude at the northernmost end is approximately 20.74°, whereas the difference between the longitude at the easternmost end and the longitude at the westernmost end is approximately 22.8°. In other words, the Japanese land is elongated along the east-west direction. Accordingly, the lateral side (east-west) and the longitudinal side (south-north) are each divided into 10 segments in units of 2.28°, which is 1/10 of the east-west difference 22.8°. A3×3-pixel icon area is allocated to each subdivision defined by dividing the 30×30-pixel area resulting from excluding the outermost single-pixel area at the periphery into 10 subdivisions. The pixels in various areas should assume different colors, as described earlier.

FIG. 5 shows an icon IC1 for Kanagawa Prefecture, presented as an example of a prefecture icon. It may be created in much the same way as that described above, by determining the latitudinal difference and the longitudinal difference manifested by the entire prefectural area, dividing both the lateral side (east-west) and the longitudinal side (south-north) into 10 segments in units equivalent to 1/10 of the greater difference, and allocating a 3×3-pixel icon area to each subdivision. While the individual pixels should take on different colors in much the same way as that described earlier, a color distinguishable from that indicating the subject prefecture should be used to indicate any part of an adjacent prefecture. Other prefecture icons should be created in this manner.

It is to be noted that there are a plurality of regions with similar shapes (prefectures and municipalities in particular). In order to ensure that their icons are easily distinguishable from one another, it is desirable to use color coding for the graphic figures representing the specific region units in those icons.

FIG. 6 shows a North American continent icon IC5, representing an example of a continent icon. This icon IC5 is created by setting a graphic figure taking on a continent shape (offset to the north for North America) inside a circle representing the globe with its radius equal to 15 pixels. Other continent icons can be created in a similar manner. A continent icon includes the globe so that the user is able to easily see that the corresponding image was photographed outside Japan.

The various types of icons described above are prepared in advance, and are stored in a database in the storage device 31 when the image display program is installed. When bringing up a thumbnail at-a-glance display based upon the image display program, the CPU 11 extracts a specific icon from the storage device 31 based upon the photographing location information included in each image file and displays the icon together with the corresponding thumbnail image (will be described in detail later).

The use of an icon for indicating the photographing location in correspondence to each thumbnail image in the thumbnail at-a-glance display described above eliminates the need for displaying the map information. Since each icon is made up with approximately 32×32 pixels, icons can be displayed for all the thumbnail images without encroaching upon the image display area. In other words, a large number of thumbnail images can be displayed at once. In addition, the storage device 31 will have to assure a very large available space in order to allow map information which has large volumes of data to be stored in the computer 100. While map information may be obtained via a network or the like and be displayed, it is bound to require a significant loading time until it is completely displayed and the user will likely suffer from delays in the display. The use of icons will eliminate the need for a large storage area and furthermore, will make it possible to bring up the display quickly.

The user is able to set in advance a single prefecture or a plurality of prefectures as a specified region (specified regions) through environment settings of the image display program or the like. In the thumbnail at-a-glance display, a prefecture icon will provide a detailed photographing location display for a photograph location within a specified region, whereas the higher-level Japan icon will provide a more general photographing location display for a photographing location outside the specified region. The user may designate a familiar prefecture of which he clearly recognizes the shape such as the prefecture where he resides or the prefecture he comes from, a prefecture where he took photographs in the past, a prefecture where he is planning to take pictures, or the like, as a specified region. When the user has taken photographs in a number of locations within a given prefecture, the individual photographing locations cannot be distinguished from one another with the same Japan icon. Accordingly, the user may designate the particular prefecture as a specified region. However, a photographing location within a prefecture with a shape that is not familiar to the user (a prefecture with a nondescript shape, for instance) may be better ascertained with the Japan icon rather than with the prefecture icon, and thus, the prefecture should not be designated as a specified region. This principle applies to any other higher-level/lower-level region unit relationship(e.g., prefecture/municipality relationship).

It is to be noted that the image display program achieved in the embodiment further has a function of displaying map information and indicating the photographing location on the map as in the related art. Once the thumbnail at-a-glance display is brought up, it may be switched to a display featuring the map information as needed.

In addition, the image display program may enable an image search based upon a region name (the name of a prefecture or a municipality) entered as a keyword, and in such a case, the icon for the region specified by the keyword may be displayed together with the search results.

FIG. 7 presents a flowchart of the procedure of thumbnail at-a-glance display processing executed by the CPU 11. In response to an image display program startup operation or a folder specifying operation performed by the user, the CPU 11 executes this processing at an instruction by the image display program.

In step S1, the CPU 11 selects one of the image files in the specified folder as a processing target. In step S2, a decision is made as to whether or not the selected image file includes photographing location information embedded therein in the form of metadata. If a negative decision is made, thumbnail data in the image file are read out and displayed in step S3. No icon indicating the photographing location is displayed.

If, on the other hand, an affirmative decision is made in step S2, the photographing location information is read out from the image file in step S4, and then in step S5, an icon indicating the photographing location is readied based upon the photographing location information. In step S6, the thumbnail data in the image file are read out and displayed, and also, the icon having been readied in step S5 is displayed. In step S7, a decision is made as to whether or not the processing described above has been executed for all the image files in the specified folder. If a negative decision is made, the next image file is selected in step S1 and the processing described above is repeatedly executed. Upon making an affirmative decision in step S7, the at-a-glance display is completed and the processing ends.

FIG. 8 presents a detailed flowchart of the icon readying processing executed in step S5.

First, in step S51, the CPU 11 makes a decision, based upon the photographing location information having been read out, as to whether or not the photographing location is in Japan. Upon making an affirmative decision in step S51, the processing proceeds to step S52, in which a decision is made as to whether or not the photographing location indicated in the photographing location information is present within any of the specified regions explained earlier. If an affirmative decision is made in step S52, a prefecture icon that includes the photographing location is readied in step S53 before the processing makes a return. This prefecture icon represents the specified region (prefecture) that includes the photographing location.

A plurality of similar icons, each having a point PT added to a specific position to indicate a photographing location, may be prepared in advance. In such a case, the icon readying operation executed in step S53 described above will be an operation through which a prefecture icon with a point PT added to the particular photographing location, among the similar prefecture icons representing the prefecture where the photographing location is present, is selected based upon the photographing location information. As an alternative, icons with no points PT indicating photographing locations added thereto may be prepared in advance, an icon for the region that contains the photographing location may be selected based upon the photographing location information, and then a point PT may be added to the selected icon at a position equivalent to the photographing location.

If a negative decision is made in step S52, i.e., if the prefecture where the photographing location is present is not a specified region, a Japan icon will be used and, accordingly, the operation proceeds to step S54. In step S54, a decision is made, based upon the photographing location information, as to whether or not the photographing location is on a remote island (whether or not the photographing location is in Okinawa or on a remote island, to be exact). Upon making an affirmative decision in step S54, the operation proceeds to step S55 in which a Japan icon that includes a remote island (such as that shown in FIG. 4) is readied before the operation makes a return. If, on the other hand, a negative decision is made in step S54, the operation proceeds to step S56, in which a Japan icon that does not include any remote islands (such as that shown in FIG. 3) is readied, and then the operation makes a return. A point indicating the photographing location is added to the icon in much the same way as the point PT is added to a prefecture icon.

If it is decided in step S51 that the photographing location is outside Japan, a continent icon (such as that shown in FIG. 6) is readied in step S57, before the operation makes a return. A point indicating the photographing location is added to the icon in much the same way as the point PT is added to a prefecture icon.

Once the complete thumbnail at-a-glance display is brought up, the user is able to select one of the thumbnail images with the mouse 22 or the like and have various types of processing executed for the image file corresponding to the selected thumbnail image. For instance, the user may choose a thumbnail image and double-click it. In response, the CPU 11 will provide a large display of the main image corresponding to the thumbnail image. The CPU 11 also displays the icon indicating the photographing location together with the main image. Since the icon only requires a very small display area as explained earlier, the main image can be displayed over a larger display area than the display area available for the main image when the map information is displayed at the same time.

It is to be noted that the photographing location present in a specified region may be close to a border of the specified area (e.g., within only several tens of meters of the border) and in such a case, it is desirable to display a higher-level designation icon (e.g., a Japan icon if the specified region is a prefecture or a prefecture icon if the specified region is a municipality). These measures should be taken in order to prevent display of an icon representing the wrong region due to a GPS positioning error. For instance, a decision may be made in step S53 in FIG. 8, as to whether or not the photographing location is in the vicinity of a border of the specified region, and upon deciding that it is close to the border, the Japan icon, i.e., a higher-level icon, should be readied, whereas upon deciding that the photographing location is not in the vicinity of a border, a prefecture icon should be readied.

In addition, the thumbnail image display size is adjustable. While display size of a thumbnail image needs to be kept down in order to be able to display a large number of thumbnail images in a single screen, the display area allocated for information appended to each thumbnail image (including the icon), too, must be kept small in such a case. When a larger thumbnail image display size is selected, the appended information display area, too, is bound to be greater. Accordingly, text indicating the name of the region represented by the icon may be additionally displayed together with the icon. In this situation, even if that particular region is not a specified region, a lower-level designation icon (a prefecture icon, a municipality icon or the like) may be displayed.

Furthermore, while at least two different types of icons, i.e., a higher-level designation icon and a lower-level designation icon, are used in the example described above, only a single type of icon (e.g., a prefecture icon) may be utilized.

In the embodiment described above, the region unit designation of the icon to be used is switched depending upon whether or not the photographing location indicated in the photograph location information included in the metadata in the image file is within a specified area selected in advance. However, the present invention is not limited to this example and the region unit designation of the icon to be displayed may be switched based upon other various conditions.

Icons may be brought up on display by adjusting the icon region unit designation in correspondence to the number of images that can be displayed at once at the display unit 32. The user is able to choose the number of images that display unit 32 is allowed to display. The phrase “the number of images that can be displayed at once at the display unit 32” refers to the greatest number of images that can be displayed in the display screen at the display unit 32 at once. The number of images that can be displayed at once at the display unit 32 may be set to, for instance, 1, 4, 9, 16 or 72. In response to an operation performed by the user at an operation unit, the CPU 11 sets the number of images that can be displayed at once at the display unit 32 to 1, 4, 9, 16 or 72. For instance, each time the user operates the operation unit, the CPU 11 may switch to a specific setting in ascending order; single image display four image display→nine image display→sixteen image display→seventy-two image display. Alternatively, each time the user operates the operation unit, the CPU 11 may switch to a specific setting in descending order; seventy-two image display→sixteen image display→nine image display→four image display→single image display.

FIG. 9 presents an example of a corresponding relationship that may exist between the number of images that can be displayed at once at the display unit 32 and the icon region unit designation.

When the number of images that can be displayed at once at the display unit 32 is set to 1, the CPU 11 displays an icon with the region unit “municipality” designation at the display unit 32. If the metadata in the image file corresponding to the image on display at the display unit 32 include photographing location information, the CPU 11 displays a municipality icon corresponding to the photographing location information together with the image at the display unit 32.

When the number of images that can be displayed at once at the display unit 32 is set to 4 or 9, the CPU 11 displays icons with the region unit designation “prefecture” at the display unit 32. Namely, if the metadata in the image file corresponding to any of the images on display at the display unit 32 include photographing location information, the CPU 11 displays a prefecture icon corresponding to the photographing location information together with the image at the display unit 32.

When the number of images that can be displayed at once at the display unit 32 is set to 16 or 72, the CPU 11 displays icons with the region unit designation “country” at the display unit 32. If the metadata in the image file corresponding to any of the images on display at the display unit 32 include photographing location information, the CPU 11 displays a country icon corresponding to the photographing location information together with the image at the display unit 32.

As described above, when the number of images that can be displayed at once at the display unit 32 is set to a greater value, icons for region units assuming wider ranges are displayed at the display unit 32. The ranges covered by the region units become greater in the order of; municipalities→prefectures→country.

An icon may be displayed by adjusting the icon region unit designation in correspondence to the resolution of the display screen at a display device. The user is able to select the resolution of the display screen at the display unit 32.

When the resolution of the display screen at the display unit 32 is set to a level equal to or higher than A and lower than B, for instance, the CPU 11 displays an icon with the region unit “country” designation at the display unit 32. Namely, if the metadata in the image file corresponding to an image on display in the display screen at the display unit 32, with the resolution at the display screen thereof set to a level equal to or higher than A and lower than B, include photographing location information, the CPU 11 displays a country icon corresponding to the photographing location information together with the image at the display unit 32.

When the resolution of the display screen at the display unit 32 is set to a level equal to or higher than B and lower than C, the CPU 11 displays an icon with the region unit “prefecture” designation at the display unit 32. Namely, if the metadata in the image file corresponding to an image on display in the display screen at the display unit 32, with the resolution at the display screen thereof set to a level equal to or higher than B and lower than C, include photographing location information, the CPU 11 displays a prefecture icon corresponding to the photographing location information together with the image at the display unit 32.

When the resolution of the display screen at the display unit 32 is set to a level equal to or higher than C, the CPU 11 displays an icon with the region unit “municipality” designation at the display unit 32. Namely, if the metadata in the image file corresponding to an image on display in the display screen at the display unit 32, with the resolution at the display screen thereof set to a level equal to or higher than C, include photographing location information, the CPU 11 displays a municipality icon corresponding to the photographing location information together with the image at the display unit 32.

While the display device is configured as the display unit 32 in the example described above, the present invention is not limited to this example. The display device may be a device other than the display unit 32, which is separately connected to the computer 100. When an image corresponding to an image file recorded in the recording device 31 is brought up on display at the display device connected to the computer 100, an icon may be displayed at the display device connected to the computer 100 by adjusting its region unit designation in correspondence to the resolution of the display screen of the display device connected to the computer 100.

As described above, as the value representing the resolution of the display screen of the display device becomes greater, i.e., when the display is provided with higher definition, an icon with the region unit designation covering a narrower range is displayed at the display device.

An icon may be displayed by adjusting the icon region unit designation in correspondence to the size of the display screen at the display device. When the size of the display screen at the display unit 32 configuring the display device is equal to or larger than A and smaller than B, for instance, an icon with the region unit “country” designation is displayed at the display unit 32. Namely, if the metadata in an image file corresponding to the image on display at the display unit 32, with a display screen equal to or larger than A and smaller than B, include photographing location information, the CPU 11 displays a country icon corresponding to the photographing location information together with the image at the display unit 32.

When the size of the display screen at the display unit 32 configuring the display device is equal to or larger than B and smaller than C, an icon with the region unit “prefecture” designation is displayed at the display unit 32. Namely, if the metadata in the image file corresponding to an image on display at the display unit 32 with a display screen equal to or larger than B and smaller than C, include photographing location information, the CPU 11 displays a prefecture icon corresponding to the photographing location information together with the image at the display unit 32.

When the size of the display screen at the display unit 32 configuring the display device is larger than C, an icon with the region unit “municipality” designation is displayed at the display unit 32. Namely, if the metadata in the image file corresponding to an image on display at the display unit 32 with a display screen equal to or larger than C, include photographing location information, the CPU 11 displays a municipality icon corresponding to the location information together with the image at the display unit 32.

While the display device is configured as the display unit 32 in the example described above, the present invention is not limited to this example. The display device may be a device other than the display unit 32, which is separately connected to the computer 100. When an image corresponding to an image file recorded in the recording device 31 is brought up on display at the display device connected to the computer 100, an icon may be displayed at the display device connected to the computer 100 by adjusting its region unit designation in correspondence to the size of the display screen of the display device connected to the computer 100.

The icon region unit designation of an icon to be displayed may be adjusted in correspondence to the photographing location indicated in photographing location information included in the image file. In more specific terms, the icon region unit designation of the icon to be displayed may be adjusted based upon whether or not the photographing location indicated in the photographing location information matches a specific position. The specific position in this case may be, for instance, a sightseeing spot. Namely, if the photographing location indicated in the photographing location information matches a specific position, an icon with the region unit “prefecture” designation is displayed. In other words, in case photographing location information is included in the metadata in the image file corresponding to an image on display at the display unit 32, if the photographing location indicated in the photographing location information matches a specific position, the CPU 11 displays a prefecture icon corresponding to the photographing location information together with the image at the display unit 32.

If the photographing location indicated in the photographing location information does not match a specific position, an icon with the region unit “municipality” designation is displayed. Namely, in case photographing location information is included in the metadata in the image file corresponding to an image on display at the display unit 32, if the photographic location indicated in the photographic location information does not match a specific position, the CPU 11 displays a municipality icon corresponding to the photographing location information together with the image at the display unit 32.

An icon may be displayed by adjusting the icon region unit designation in correspondence to the language setting. A language setting is selected to specify a preferred language in which text is to be displayed on the display screen of the display device. The term “language setting” used in this context refers to a preferred language set at devices (cameras, personal computers and the like) and in application programs (image editing application programs and the like).

More specifically, an icon may be displayed by adjusting its region unit designation based upon whether the photographing location indicated in the photographing location information corresponds to the language setting or the photographing location indicated in the photographing location information does not correspond to the language setting. For instance, when an image corresponding to an image file containing metadata that include photographing location information indicating the USA as the photographing location is brought up on display at the display unit 32, for which Japanese is selected as the language setting, the CPU 11 displays a country icon corresponding to the photographing location information, i.e., a USA icon, together with the image at the display unit 32. When an image corresponding to an image file containing metadata that include photographing location information indicating Japan as the photographing location is brought up on display at the display unit 32, for which Japanese is selected as the language setting, the CPU 11 displays a prefecture icon corresponding to the photographing location information together with the image at the display unit 32.

An icon may be displayed by adjusting the icon region unit designation in correspondence to user information. The user information indicates the user's nationality, the user's residential address and the like. The term “user information” used in this context refers to user information set in devices (cameras, personal computers and the like) and user information set in application programs (image editing application programs and the like).

More specifically, an icon may be displayed by adjusting its region unit designation based upon whether the photographing location indicated in photographing location information is in correspondence to the user information or the photographing location indicated in the photographing location information is not in correspondence to the user information.

For instance, when an image corresponding to an image file containing metadata that include photographing location information indicating the USA as the photographing location is brought up on display at the display unit 32, for which user information indicating Japanese nationality is set, the CPU 11 displays a country icon corresponding to the photographing location information, i.e., a USA icon, together with the image at the display unit 32. When an image corresponding to an image file containing metadata that include photographing location information indicating Japan as the photographing location is brought up on display at the display unit 32, for which user information indicating Japanese nationality is set, the CPU 11 displays a prefecture icon corresponding to the photographing location information together with the image at the display unit 32.

When an image corresponding to an image file containing metadata that include photographing location information indicating the USA as the photographing location is brought up on display at the display unit 32, for which user information indicating a Japanese address is set, the CPU 11 displays a country icon corresponding to the photographing location information, i.e., a USA icon, together with the image at the display unit 32. When an image corresponding to an image file containing metadata that include photographing location information indicating Japan as the photographing location is brought up on display at the display unit 32, for which user information indicating a Japanese address is set, the CPU 11 displays a prefecture icon corresponding to the photographing location information together with the image at the display unit 32.

An icon may be displayed by adjusting the icon region unit designation in correspondence to the number of times the image has been displayed. The phrase “the number of times the image has been displayed” refers to the number of times an image corresponding to a given image file has been displayed at the display device such as the display unit 32.

If the number of times the image has been displayed is equal to or larger than 1 and smaller than A, the CPU 11 displays an icon with the region unit “country” designation at the display unit 32. Namely, in case an image file corresponding to an image on display at the display unit 32 includes photographing location information in its metadata, when the image has been displayed at least once and fewer than A times, the CPU 11 displays a country icon corresponding to the photographing location information together with the image at the display unit 32.

If the number of times the image has been displayed is equal to or larger than A and smaller than B, the CPU 11 displays an icon with the region unit “prefecture” designation at the display unit 32. Namely, in case an image file corresponding to an image on display at the display unit 32 includes photographing location information in its metadata, when the image has been displayed at least A times and fewer than B times, the CPU 11 displays a prefecture icon corresponding to the photographing location information together with the image at the display unit 32.

If the number of times the image has been displayed is equal to or larger than B, the CPU 11 displays an icon with the region unit “municipality” designation at the display unit 32. Namely, in case an image file corresponding to an image on display at the display unit 32 includes photographing location information in its metadata, when the image has been displayed B times or more, the CPU 11 displays a municipality icon corresponding to the photographing location information together with the image at the display unit 32.

An icon may be displayed by adjusting the icon region unit designation in correspondence to the difference between the current time point and the photographing date/time. The term “current time” in this context refers to the time set in devices (cameras, personal computers and the like). The photographing date/time is the time point indicated in the photographing date/time information included in the metadata in the image file. The photographing date/time is the time point at which the image file was generated through a photographing operation performed at the camera.

If the difference between the current time and the photographing date/time is less than A, the CPU 11 displays an icon with the region unit “country” designation at the display unit 32. Namely, if the metadata in the image file corresponding to an image on display at the display unit 32 include photographing location information, the CPU 11 displays a country icon corresponding to the photographing location information together with the image at the display unit 32, provided that the difference between the current time and the photographing date/time is less than A.

If the difference between the current time and the photographing date/time is equal to or larger than A and smaller than B, the CPU 11 displays an icon with the region unit “prefecture” designation at the display unit 32. Namely, if the metadata in the image file corresponding to an image on display at the display unit 32 include photographing location information, the CPU 11 displays a prefecture icon corresponding to the photographing location information together with the image at the display unit 32, provided that the difference between the current time and the photographing date/time is equal to or larger than A and smaller than B.

If the difference between the current time and the photographing date/time is equal to or larger than B, the CPU 11 displays an icon with the region unit “municipality” designation at the display unit 32. Namely, if the metadata in the image file corresponding to an image on display at the display unit 32 include photographing location information, the CPU 11 displays a municipality icon corresponding to the photographing location information together with the image at the display unit 32, provided that the difference between the current time and the photographing date/time is equal to or larger than B.

### Second Embodiment

In the first embodiment described above, an icon providing information indicating the photographing location is displayed for each of the corresponding thumbnail image. When a plurality of images are displayed at the display device, fewer icons providing information indicating photographing locations are displayed relative to the number of images on display at the display device in the second embodiment. A specific example in which a single icon is displayed to provide information indicating a photographing location for a plurality of images sharing a common condition will be described below. It is to be noted that a system configuration similar to that in the first embodiment, comprising a computer and a digital camera, is adopted, and accordingly, a repeated explanation is not provided.

Images with the photographing date/time information included in the metadata in the corresponding image files falling into a predetermined time period, for instance, may be regarded to belong to a single group. In such a case, a single icon is displayed for the same group. When a plurality of image files belong to a group, the icon displayed for this is readied based upon the photographing location information included in the metadata in one of the image files among the plurality of image files in the group.

FIG. 10 provides a chart indicating how image files may be sorted into different groups. It is assumed that image file 1 through image file 9 each contain metadata that include photographing location information. A file name is assigned as an image file is generated in response to a photographing operation performed at the camera. The file name may be assigned to the image file each time an image is taken with the camera by, for instance, incrementing the numerical value in the file name by one. A decision as to whether or not a given image file belongs to a specific group may be made based upon, for instance, whether or not the difference between the photographing date/time for the decision-making target image file and the photographing date/time for the image file immediately preceding the decision-making target image file is less than 10 minutes set as the predetermined time period.

An explanation will be given in reference to image file 2 designated as the decision-making target image file. The photographing date/time for image file 2 is 2013/02/26 09:33:18. Assuming that the image files are sorted based upon their file names in ascending order, the image file that immediately precedes image file 2 is image file 1. The image in image file 1 was taken at 2013/02/26 09:03:07. In other words, the photographing date/time for image file 2 is set apart by more than 10 minutes from the photographing date/time for image file 1. Accordingly, image file 1 and image file 2 are determined to belong to different groups. Namely, assuming that image file 1 belongs to group 1, image file 2 is assigned to group 2 instead of group 1.

An explanation will be given in reference to image file 3 designated as the decision-making target image file. The photographing date/time for image file 3 is 2013/02/26 09:36:25. Assuming that image file 1 through image file 9 are sorted based upon their file names in ascending order, the image file that immediately precedes image file 3 is image file 2. The image in image file 2 was taken at 2013/02/06 09:33:18. The photographing date/time for image file 3 is separated by less than 10 minutes from the photographing date/time for image file 2. In other words, the difference between the photographing date/time for image file 2 and the photographing date/time for image file 3 is less than 10 minutes. Accordingly, image file 2 and image file 3 are determined to belong to the same group. Assuming that image file 2 belongs to group 2, image file 3, too, is thus assigned to group 2. While the numerical value in the file name of image file 2 and the numerical value in the file name of image file 3 are not consecutive numbers, image file 2 and image file 3 are still regarded to belong to the same group since the difference between the photographing date/time for image file 2 and the photographing date/time for image file 3 is less than 10 minutes.

FIG. 11 shows how images, each corresponding to one of image file 1 through image file 9, may be brought up at the display unit 32 when the number of images that can be displayed at once at the display unit 32 is set to 9.

While the metadata for image file 2 through image file 5 all include photographing location information, image file 2 through image file 5 all belong to a single group, i.e., group 2, and accordingly, a single common icon is displayed for image file 2 through image file 5. The icon is displayed at a position corresponding to the image in image file 2 that is the image file with the file name indicating the lowest numerical value among the image files in group 2.

It is to be noted that while an example in which a single icon is displayed for each group has been described, the present invention is not limited to this example. For instance, the icon may be displayed in correspondence to the image in image file 4, as well as for the image in image file 2, i.e., the image file with the file name indicating the lowest numerical value among the image files belonging to group 2. As FIG. 11 shows, the image in image file 2 and the image in image file 3 are displayed in the first row at the display unit 32, whereas the image in image file 4 and the image in image file 5 are displayed in the second row at the display unit 32. While the images in image file 2 and image file 3 and the images in image file 4 and image file 5 all belong to a common group, i.e., group 2, the latter two images are displayed in a different row from that in which the former two images are displayed at the display unit 32. Accordingly, the icon may be displayed in correspondence to the image displayed at the beginning (the left side in FIG. 11) of each row at the display unit 32.

Likewise, while the image in image file 6 and the image in image file 7 both belong to group 3, the image in image file 6 is displayed in the second row and the image in image file 7 is displayed in the third row at the display unit 32. Accordingly, the icon may be displayed in correspondence to the image in image file 7 taking up the starting position in a display row at the display unit 32, in addition to the icon displayed in correspondence to the image in image file 6 with the file name thereof indicating the lowest numerical value among the image files belonging to group 3.

The icon indicates the photographing location based upon the photographing location information included in the metadata in the image file with the file name thereof indicating the lowest numerical value among the image files belonging to the same group.

For instance, the icon for group 2, to which image file 2 through image file 5 belong is readied based upon the photographing location information included in the metadata in image file 2 with the file name thereof indicating the lowest numerical value among image file 2 through image file 5. However, the present invention is not limited to this example and the icon may indicate the photographing location based upon the photographing location information in any of the image files belonging to the same group. For instance, an icon readied based upon the photographing location information included in the metadata in image file 3 may be displayed at the display unit 32 in correspondence to the image in image file 2. Likewise, an icon readied based upon the photographing location information included in the metadata in image file 4 may be displayed at the display unit 32 in correspondence to the image in image file 2. Furthermore, an icon readied based upon the photographing location information included in the metadata in image file 5 may be displayed at the display unit 32 in correspondence to the image in image file 2.

As shown in FIG. 11, group-partitioning bars may be displayed at the display unit 32 so as to indicate the grouping assignment with clarity at the display unit 32. For instance, such a group-partitioning bar may be displayed between group 1 and group 2, i.e., between the image in image file 1 and the image in image file 2.

While the grouping assignment is indicated with group partitioning bars in the example described above, the present invention is not limited to this example. For instance, the grouping assignment may be indicated with a frame that encloses all the images belonging to a specific group.

It is to be noted that a group partitioning bar or a frame indicating the grouping assignment does not need to be displayed between a group made up with a single image and a group made up with a single image. A grouping assignment mark may be displayed between a group made up with a plurality of images and a group made up with a single image. In the latter case, the grouping assignment may be indicated by displaying a frame enclosing the group made up with the plurality of images with no frame displayed for the group made up with the single image.

While image files are grouped based upon the photographing date/time information included in the metadata in the image files in the example described above, the present invention is not limited to this example. For instance, a plurality of image files taken through a continuous shooting operation performed at the camera may be regarded to belong to a common group. In this case, each of the plurality of image files taken through a continuous shooting operation may be appended with a continuous shooting flag (information indicating that the particular image was taken through a continuous shooting operation) at the camera so as to allow image files to be grouped based upon whether or not the continuous shooting flag is appended to the individual image files.

A display may be provided by switching to a display mode (in which an icon providing information indicating the photographing location is displayed for each corresponding image), such as that shown in in FIG. 2, in reference to which the first embodiment has been described, or to a display mode (in which fewer icons providing information indicating the photographing locations are displayed compared to the number of images corresponding to image files containing photographing location information), such as that shown in FIG. 11, in reference to which the current embodiment has been described. Such a display mode switchover may take place in response to, for instance, a user operation. The display modes may be switched based upon, for instance, whether or not a plurality of images to be brought up on display at the display unit 32 include continuously shot images. If the plurality of images to be displayed at the display unit 32 include continuously shot images, the plurality of images may be displayed by adopting the display mode shown in FIG. 11 in reference to which the current embodiment has been described, whereas if the plurality of images to be displayed at the display unit 32 do not include any continuously shot images, the plurality of images may be displayed by adopting the display mode shown in FIG. 2 in reference to which the first embodiment has been described.

### Third Embodiment

In the first embodiment described earlier, when the metadata in an image file include photographing location information, information indicating the photographing location is provided in the form of an icon in the display. In the third embodiment to be described next, when an image file contains metadata that include photographing location information, the information indicating the photographing location is displayed by switching display modes based upon various conditions. It is to be noted that since a system configuration comprising a computer and a digital camera, which is similar to that in the first embodiment, is adopted, a repeated explanation is not provided.

The information indicating the photographing location may be provided in a display mode in which the information indicating the photographing location is displayed in the form of an icon instead of text. The information indicating the photographing location may instead be provided in a display mode in which the information is provided in the form of text as well as in the form of an icon. There may also be a photographing location information display mode, in which the information indicating the photographing location is withheld from the display even if the metadata in the image file include photographing the location information, i.e., a mode in which neither icon nor text is displayed. It is to be noted that text display of the information indicating the photographing location may provide the latitude/longitude of the photographing location or the address of the photographing location. It is also to be noted that the term “text” includes hiragana characters, kanji characters, katakana characters, alphabetic characters, numerals and symbols. In addition, if the photographing location indicated in the photographing location information in an image file matches a sightseeing spot, the name of the sightseeing spot may be displayed as the information indicating the photographing location instead of the latitude/longitude or the address. For instance, the information indicating the photographing location for an image file containing an image taken at Tokyo Tower, i.e., a sightseeing spot, may read “Tokyo Tower (in kanji and hiragana”, “TOKYO TOWER(in alphabet)” or the like.

Information indicating photographing locations is displayed at the display device by switching display modes in correspondence to the number of images that can be displayed at once at the display unit 32. FIG. 12 presents an example of a corresponding relationship that may be assumed between the number of images that can be displayed at once at the display unit 32 and the display mode adopted for the information indicating photographing locations.

When the number of images that can be displayed at once at the display unit 32 is set to 1, the CPU 11 displays the information indicating the photographing location both in the form of an icon and in the form of text at the display unit 32. In this case, as long as the metadata in the image file corresponding to the image on display at the display unit 32 include photographing location information, the CPU 11 displays an icon and text corresponding to the photographing location information together with the image at the display unit 32.

When the number of images that can be displayed at once at the display unit 32 is set to 4, the CPU 11 displays information indicating a photographing location in the form of text rather than in the form of an icon at the display unit 32. Namely, for any image corresponding to an image file with metadata that include photographing location information among the images on display at the display unit 32, the CPU 11 displays text corresponding to the photographing location information together with the image at the display unit 32.

When the number of images that can be displayed at once at the display unit 32 is set to 9 or 16, the CPU 11 displays information indicating a photographing location in the form of an icon rather than in the form of text at the display unit 32. Namely, for any image corresponding to an image file with metadata that include photographing location information among the images on display at the display unit 32, the CPU 11 displays an icon corresponding to the photographing location information together with the image at the display unit 32.

When the number of images that can be displayed at once at the display unit 32 is set to 72, the CPU 11 does not display any information indicating the photographing location at the display unit 32 even for an image corresponding to an image file with metadata that include photographing location information.

Information indicating a photographing location may be displayed at the display device by switching display modes in correspondence to the resolution of the display screen at the display device.

When the resolution of the display screen at the display unit 32 is, for instance, at a level equal to or higher than A and lower than B, the CPU 11 does not display any information indicating the photographing location at the display unit 32 at all.

When the resolution of the display screen at the display unit 32 is equal to or higher than B and lower than C, the CPU 11 displays information indicating the photographing location in the form of an icon rather than in the form of text at the display unit 32. Namely, if the metadata in the image file corresponding to an image on display at the display unit 32, with the resolution at the display screen thereof set to a level equal to or higher than B and lower than C, include photographing location information, the CPU 11 displays an icon providing information indicating the photographing location together with the image at the display unit 32.

When the resolution of the display screen at the display unit 32 is equal to or higher than C and lower than D, the CPU 11 displays information indicating the photographing location in the form of text rather than in the form of an icon at the display unit 32. Namely, if the metadata in the image file corresponding to an image on display at the display unit 32, with the resolution at the display screen thereof set to a level equal to or higher than C and lower than D, include photographing location information, the CPU 11 displays text providing information indicating the photographing location together with the image at the display unit 32.

When the resolution of the display screen at the display unit 32 is equal to or higher than D, the CPU 11 displays information indicating the photographing location both in the form of text and in the form of an icon at the display unit 32. Namely, if the metadata in the image file corresponding to an image on display at the display unit 32 with the resolution at the display screen thereof set to a level equal to or higher than D, include photographing location information, the CPU 11 displays an icon and text providing information indicating the photographing location together with the image at the display unit 32.

While the display device is configured as the display unit 32 in the example described above, the present invention is not limited to this example. The display device may be a device other than the display unit 32, which is separately connected to the computer 100. When an image corresponding to an image file recorded in the recording device 31 is brought up at the display device connected to the computer 100, information indicating the photographing location may be displayed at the display unit connected to the computer 100 by switching to a specific display mode in correspondence to the resolution of the display screen at the display device connected to the computer 100.

Information indicating a photographing location may be displayed by switching display modes in correspondence to the size of the display screen at the display device.

For instance, when the size of the display screen at the display unit 32 configuring the display device is equal to or larger than A and smaller than B, the CPU 11 does not display any information indicating the photographing location at the display unit 32.

When the size of the display screen at the display unit 32 configuring the display device is, for instance, equal to or larger than B and smaller than C, the CPU 11 displays information indicating the photographing location in the form of an icon rather than in the form of text at the display unit 32. Namely, if the metadata in the image file corresponding to an image on display at the display unit 32, with a display screen size equal to or larger than B and smaller than C, include photographing location information, the CPU 11 displays an icon providing information indicating the photographing location together with the image at the display unit 32.

When the size of the display screen at the display unit 32 configuring the display device is equal to or larger than C and smaller than D, the CPU 11 displays information indicating the photographing location in the form of text rather than in the form of an icon at the display unit 32. Namely, if the metadata in the image file corresponding to an image on display at the display unit 32 with a display screen size equal to or larger than C and smaller than D, include photographing location information, the CPU 11 displays text providing information indicating the photographing location together with the image at the display unit 32.

When the size of the display screen at the display unit 32 configuring the display device is equal to or larger than D, the CPU 11 displays information indicating the photographing location both in the form of text and in the form of an icon at the display unit 32. Namely, if the metadata in the image file corresponding to an image on display at the display unit 32 with a display screen size larger than D, include photographing location information, the CPU 11 displays an icon and text providing information indicating the photographing location together with the image at the display unit 32.

While the display device is configured as the display unit 32 in the example described above, the present invention is not limited to this example. The display device may be a device other than the display unit 32, which is separately connected to the computer 100. When an image corresponding to an image file recorded in the recording device 31 is brought up on display at the display device connected to the computer 100, information indicating the photographing location may be displayed at the display device connected to the computer 100 by switching to a specific display mode in correspondence to the size of the display screen at the display device connected to the computer 100.

Information indicating a photographing location may be displayed at the display device by switching display modes in correspondence to the photographing location indicated in photographing location information included in an image file.

More specifically, information indicating the photographing location may be displayed at the display device by switching display modes based upon whether or not the photographing location indicated in the photographing location information matches a specific position. Such a specific position may be, for instance, a sightseeing spot.

In this case, when the photographing location indicated in the photographing location information matches a specific position, information indicating the photographic location is displayed at the display unit 32 in the form of text rather than an icon. In other words, in case photographing location information is included in the metadata in the image file corresponding to an image on display at the display unit 32, if the photographing location indicated in the photographing location information matches a specific position, the CPU 11 displays information indicating the photographing location in the form of text together with the image at the display unit 32.

If the photographing location indicated in the photographing location information does not match a specific position, information indicating the photographing location is displayed at the display unit 32 in the form of an icon rather than in the form of text. Namely, in case the photographing location information is included in the metadata in the image file corresponding to an image on display at the display unit 32, if the photographing location indicated in the photographing location information does not match a specific position, the CPU 11 displays information indicating photographing location in the form of an icon together with an image at the display unit 32. It is to be noted that when the photographing location indicated in the photographing location information does not match a specific position, the information indicating the photographing location may instead be displayed both in the form of an icon and in the form of text at the display unit 32.

Information indicating a photographing location may be displayed at the display device by switching display modes in correspondence to the language setting. A language setting is selected to specify a preferred language in which text is to be displayed on the display screen of the display device. The term “language setting” in this context refers to a preferred language set at devices (cameras, personal computers and the like) and in application programs (image editing application programs and the like).

More specifically, information indicating the photographing location may be displayed at the display device by switching display modes based upon whether or not the photographing location indicated in the photographing location information is in correspondence to the language setting.

For instance, when an image corresponding to an image file containing metadata that include photographing location information indicating the USA as the photographing location is brought up on display at the display unit 32, for which Japanese is selected as the language setting, the CPU 11 displays information indicating the photographing location in the form of an icon rather than in the form of text together with the image at the display unit 32.

When an image corresponding to an image file containing metadata that include photographing location information indicating Japan as the photographing location is brought up on display at the display unit 32, for which Japanese is selected as the language setting, the CPU 11 displays the information indicating the photographing location in the form of text rather than in the form of an icon together with the image at the display unit 32.

It is to be noted that the following alternative may be adopted.

When displaying an image corresponding to an image file containing metadata that include photographing location information indicating the USA as the photographing location at the display unit 32, for which Japanese is selected as the language setting, the CPU 11 displays information indicating the photographing location in the form of text rather than in the form of an icon together with the image at the display unit 32.

When an image corresponding to an image file containing metadata that include photographing location information indicating Japan as the photographing location is brought up on display at the display unit 32, for which Japanese is selected as the language setting, the CPU 11 displays information indicating the photographing location in the form of an icon rather than in the form of text together with the image at the display unit 32.

Information indicating a photographing location may be displayed at the display device by switching display modes in correspondence to user information. The user information indicates the user's nationality, the user's residential address and the like.

The term “user information” used in this context refers to user information set in devices (cameras, personal computers and the like) and user information set in application programs (image editing application programs and the like).

More specifically, information indicating the photographing location may be displayed at the display device by switching display modes based upon whether the photographing location indicated in photographing location information is in correspondence to the user information or the photographing location indicated in the photographing location information is not in correspondence to the user information.

For instance, when an image corresponding to an image file containing metadata that include photographing location information indicating the USA as the photographing location is brought up on display at the display unit 32, for which user information indicating Japanese nationality is set, the CPU 11 displays information indicating the photographing location in the form of an icon rather than in the form of text together with the image at the display unit 32.

When an image corresponding to an image file containing metadata that include photographing location information indicating Japan as the photographing location is brought up on display at the display unit 32, for which user information indicating Japanese nationality is set, the CPU 11 displays Information indicating the photographing location in the form of text rather than in the form of an icon together with the image at the display unit 32.

When an image corresponding to an image file containing metadata that include photographing location information indicating the USA as the photographing location is brought up on display at the display unit 32, for which user information indicating a Japanese address is set, the CPU 11 displays information indicating the photographing location in the form of an icon rather than in the form of text together with the image at the display unit 32.

When an image corresponding to an image file containing metadata that include photographing location information indicating Japan as the photographing location is brought up on display at the display unit 32, for which user information indicating a

Japanese address is set, the CPU 11 displays information indicating the photographing location in the form of text rather than in the form of an icon together with the image at the display unit 32.

It is to be noted that the following alternative may be adopted.

When an image corresponding to an image file containing metadata that include photographing location information indicating the USA as the photographing location is brought up on display at the display unit 32, for which Japanese nationality is set in the user information, the CPU 11 displays information indicating the photographing location in the form of text rather than in the form of an icon together with the image at the display unit 32.

When an image corresponding to an image file containing metadata that include photographing location information indicating Japan as the photographing location is brought up on display at the display unit 32, for which Japanese nationality is set in the user information, the CPU 11 displays information indicating the photographing location in the form of an icon rather than in the form of text together with the image at the display unit 32.

When an image corresponding to an image file containing metadata that include photographing location information indicating the USA as the photographing location is brought up on display at the display unit 32, for which user information indicating a Japanese address is set, the CPU 11 displays information indicating the photographing location is the form of text rather than in the form of an icon together with the image at the display unit 32.

When an image corresponding to an image file containing metadata that include photographing location information indicating Japan as the photographing location is brought up on display at the display unit 32, for which user information indicating a Japanese address is set, the CPU 11 displays information indicating the photographing location in the form of an icon rather than in the form of text together with the image at the display unit 32.

Information indicating the photographing location may be displayed at the display device by switching display modes in correspondence to the number of times the image has been displayed. The phrase “the number of times the image has been displayed” refers to the number of times an image corresponding to a given image file has been displayed at a display device such as the display unit 32.

If the number of times the image has been displayed is equal to or larger than 1 and smaller than A, the CPU 11 displays information indicating the photographing location in the form of an icon rather than in the form of text at the display unit 32. Namely, if an image on display at the display unit 32 corresponding to an image file containing metadata that include photographing location information has been displayed at least once and fewer than A times, the CPU 11 displays information indicating the photographing location in the form of an icon rather than in the form of text together with the image at the display unit 32.

If the number of times the image has been displayed is equal to or larger than A and smaller than B, the CPU 11 displays information indicating the photographing location in the form of text rather than in the form of an icon at the display unit 32. Namely, if an image on display at the display unit 32 corresponding to an image file containing metadata that include photographing location information has been displayed at least A times and fewer than B times, the CPU 11 displays information indicating the photographing location in the form of text rather than in the form of an icon together with the image at the display unit 32.

If the number of times the image has been displayed is equal to or larger than B, the CPU 11 displays information indicating the photographing location both in the form of text and in the form of an icon at the display unit 32. Namely, if an image on display at the display unit 32 corresponding to an image file containing metadata that include photographing location information has been displayed B times or more, the CPU 11 displays information indicating the photographing location in the form of text and in the form of an icon together with the image at the display unit 32.

It is to be noted that the following alternative may be adopted.

If the number of times the image has been displayed is equal to or larger than 1 and smaller than A, the CPU 11 does not display information indicating the photographing location at the display unit 32.

If the number of times the image has been displayed is equal to or larger than A and smaller than B, the CPU 11 displays information indicating the photographing location in the form of an icon rather than in the form of text at the display unit 32.

Namely, if an image on display at the display unit 32 corresponding to an image file containing metadata that include photographing location information has been displayed at least A times and fewer than B times, the CPU 11 displays information indicating the photographing location in the form of an icon rather than in the form of text together with the image at the display unit 32.

If the number of times the image has been displayed is equal to or larger than B and smaller than C, the CPU 11 displays information indicating the photographing location in the form of text rather than in the form of an icon at the display unit 32. Namely, if an image on display at the display unit 32 corresponding to an image file containing metadata that include photographing location information has been displayed at least B times and fewer than C times, the CPU 11 displays information indicating the photographing location in the form of text rather than in the form of an icon together with the image at the display unit 32.

If the number of times the image has been displayed is equal to or larger than C, the CPU 11 displays information indicating the photographing location both in the form of text and in the form of an icon at the display unit 32. Namely, if an image on display at the display unit 32 corresponding to an image file containing metadata that include photographing location information has been displayed C times or more, the CPU 11 displays information indicating the photographing location in the form of text and in the form of an icon together with the image at the display unit 32.

Information indicating the photographing location may be displayed at the display device by switching display modes in correspondence to the difference between the current time point and the photographing date/time. The term “current time” in this context refers to the time set in devices (cameras, personal computers and the like). The photographing date/time is the time point indicated in the photographing date/time information included in the metadata in the image file. The photographing date/time is the time point at which the image file was generated through a photographing operation performed at the camera.

If the difference between the current time and the photographing date/time is less than A, the CPU 11 displays information indicating the photographing location in the form of an icon rather than in the form of text at the display unit 32. Namely, if the metadata in the image file corresponding to an image on display at the display unit 32 include photographing location information, the CPU 11 displays information indicating the photographing location in the form of an icon rather than in the form of text together with the image at the display unit 32, provided that the difference between the current time and the photographing date/time is less than A.

If the difference between the current time and the photographing date/time is equal to or larger than A and smaller than B, the CPU 11 displays information indicating the photographing location in the form of text rather than in the form of an icon at the display unit 32. Namely, if the metadata in the image file corresponding to an image on display at the display unit 32 include photographing location information, the CPU 11 displays information indicating the photographing location in the form of text rather than in the form of an icon together with the image at the display unit 32, provided that the difference between the current time and the photographing date/time is equal to or larger than A and smaller than B.

If the difference between the current time and the photographing date/time is equal to or larger than B, the CPU 11 displays information indicating the photographing location both in the form of an icon and in the form of text at the display unit 32. Namely, if the metadata in the image file corresponding to an image on display at the display unit 32 include photographing location information, the CPU 11 displays information indicating the photographing location in the form of an icon and in the form of text together with the image at the display unit 32, provided that the difference between the current time and the photographing date/time is equal to or larger than B.

If the difference between the current time and the photographing date/time is less than A, the CPU 11 does not display information indicating the photographing location at the display unit 32.

If the difference between the current time and the photographing date/time is equal to or larger than A and smaller than B, the CPU 11 displays information indicating the photographing location in the form of an icon rather than in the form of text at the display unit 32. Namely, if the metadata in the image file corresponding to an image on display at the display unit 32 include photographing location information, the CPU 11 displays information indicating the photographing location in the form of an icon rather than in the form of text together with the image at the display unit 32, provided that the difference between the current time and the photographing date/time is equal to or larger than A and smaller than B.

If the difference between the current time and the photographing date/time is equal to or larger than B and smaller than C, the CPU 11 displays information indicating the photographing location in the form of text rather than in the form of an icon at the display unit 32. Namely, if the metadata in the image file corresponding to an image on display at the display unit 32 include photographing location information, the CPU 11 displays information indicating the photographing location in the form of text rather than in the form of an icon together with the image at the display unit 32, provided that the difference between the current time and the photographing date/time is equal to or larger than B and smaller than C.

If the difference between the current time and the photographing date/time is equal to or larger than C, the CPU 11 displays information indicating the photographing location both in the form of an icon and in the form of text at the display unit 32. Namely, if the metadata in the image file corresponding to an image on display at the display unit 32 include photographing location information, the CPU 11 displays information indicating the photographing location in the form of an icon and in the form of text together with the image at the display unit 32, provided that the difference between the current time and the photographing date/time is equal to or larger than C.

Information indicating the photographing location may be displayed at the display device by switching display modes based upon whether or not a specific type of subject is included in the image.

When the image contains a human subject, the CPU 11 does not display information indicating the photographing location at the display unit 32. When the image does not contain a human subject, the CPU 11 displays information indicating the photographing location in the form of an icon rather than in the form of text at the display unit 32. It is to be noted that when the image does not contain a human subject, the CPU 11 may display information indicating the photographing location in the form of text rather than in the form of an icon at the display unit 32 or it may display information indicating the photographing location both in the form of an icon and in the form of text at the display unit 32, instead. It is also to be noted that the display mode for the information indicating the photographing location to be assumed when the image does not contain a human subject may be freely selected by the user.

Information indicating a photographing location may be displayed at the display device by switching display modes in correspondence to the operation mode.

When an image-capturing mode is selected for the operation mode in the camera, information indicating the photographing location is displayed in the display unit of the camera in the form of an icon rather than in the form of text together with a live view image.

When a reproducing mode is selected for the operation mode in the camera, information indicating the photographing location is displayed in the display unit of the camera, either in the form of text rather than in the form of an icon or both in the form of an icon and in the form of text, together with the reproduced image. It is to be noted that the display mode for the information indicating the photographing locations, to be assumed when the reproducing mode is selected for the operation mode in the camera, may be freely selected by the user.

The user may be allowed to freely select a preferred display mode among the display mode in which information indicating the photographing location is displayed in the form of an icon rather than in the form of text, the display mode in which information indicating the photographing locations is displayed in the form of text rather than an icon, the display mode in which information indicating the photographing location is displayed both in the form of an icon and in the form of text and the display mode in which no information indicating the photographing location is displayed, i.e., neither an icon nor text is displayed, even for an image file with metadata that include photographing location information.

In the embodiments described above, the image transfer program, the image display program and the like are pre-installed in the storage device 31. These programs may be provided to the computer 100 via various types of recording media such as a CD-ROM, a DVD and a USB memory or in data signals on the Internet or the like. FIG. 13 illustrates how such a program may be provided. The computer 100 takes in the program via, for instance, a CD-ROM 104. The computer 100 also has a function that allows it to connect with a communication line 101. A server computer 102 is a computer that provides the program stored in a recording medium such as a hard disk 103. The communication line 101 may be a communication network such as the Internet or it may be a dedicated communication line. The server computer 102 transmits the program, read out from the hard disk 103, to the computer 100 via the communication line 101. Namely, the program embodied as a data signal is transmitted on a carrier wave via the communication line 101. In short, the program may be provided as a computer-readable computer program product adopting any of various modes including a recording medium and a data signal.

While the invention has been particularly shown and described with respect to preferred embodiments and variations thereof, the present invention is not limited to these examples and it will be understood by those skilled in the art that various changes in form and detail may be made therein without departing from the spirit, scope and teaching of the invention.

The disclosure of the following priority application is herein incorporated by reference: Japanese Patent Application No. 2012-040158 filed Feb. 27, 2012.

1. A computer program product containing an display program that enables a computer to execute:
a function of displaying an image based upon image data;
a function of readying an icon based upon photographing location information indicating a photographing location, which is made to correspond to the image data, by drawing a pointer indicating the photographing location on a graphic figure representing an approximate shape of a region unit containing the photographing location; and
a function of displaying the icon having been readied together with the image to be displayed.

2. The computer program product according to claim 1, wherein:
in a readying phase during which the icon is readied, a decision is made in correspondence to a condition as to whether to use an icon with a predetermined unit designation corresponding to a predetermined region unit or to use an icon with a lower-level unit designation corresponding to a lower-level region unit relative to the predetermined region unit.

3. The computer program product according to claim 2, wherein:
a decision is made as to whether to use the icon with the predetermined unit designation or the icon with the lower-level unit designation based upon a user setting selected in advance.

4. The computer program product according to claim 3, wherein:
a setting indicating whether or not the icon with the lower-level unit designation is to be used can be selected in correspondence to each lower-level region unit, and a decision as to whether to use the icon with the predetermined unit designation or the icon with the lower-level unit designation is made based upon the setting.

5. The computer program product according to claim 2, wherein:
a decision as to whether to use the icon with the predetermined unit designation or the icon with the lower-level unit designation is made based upon the photographing location information.

6. The computer program product according to claim 5, wherein:
the icon with the predetermined unit designation is readied if the photographing location indicated in the photographing location information is near a border separating two or more lower-level region units.

7. The computer program product according to claim 1, wherein:
when providing an at-a-glance display of thumbnail images based upon a plurality of sets of image data, the icon is readied and displayed in correspondence to each of the thumbnail images.

8. An image display device comprising:
a display unit at which an image can be displayed based upon image data;
an icon readying unit that readies an icon based upon photographing location information indicating a photographing location, which is made to correspond to the image data, by drawing a pointer indicating the photographing location on a graphic figure representing an approximate shape of a region unit containing the photographing location; and
a display control unit that displays the icon having been readied at the display unit together with the image to be displayed.

9. A computer program product containing an image display program that enables a computer to execute:
a function of displaying an image corresponding to each of a plurality of sets of image data and a region indicating a photographing location of the image; and
a function of displaying the region while varying a range of the region according to the photographing location of the image.

10. An image display device comprising:
a display unit that displays an image corresponding to each of a plurality of sets of image data and a region indicating a photographing location of the image; and
a control unit that controls the display unit to display the region while varying a range of the region according to the photographing location of the image.
